(19) United States
(12) Patent Application Publication
(10) Pub. No.: US 2022/0032228 A1
(43) Pub. Date: Feb. 3, 2022

(54) HYDROGEN RECYCLE SYSTEM

(71) Applicant: DINGJIA ENERGY CO., LTD., Xinbei City (TW)

(72) Inventor: Ming-Yu Yen, Hsinchu County (TW)

(21) Appl. No.: 17/280,535

(22) PCT Filed: Aug. 12, 2019
(86) PCT No.: PCT/CN2019/100172

§ 371 Date: Mar. 26, 2021

(30) Foreign Application Priority Data
Sep. 29, 2018 (CN) 201811145711.2

(51) Int. Cl. B01D 53/32; C01B 3/56; C01B 3/50; B01D 53/26; B01D 53/18

(52) U.S. Cl. CPC B01D 53/326; C01B 3/56; C01B 3/503; B01D 53/261; B01D 53/265; B01D 53/18; B01D 2253/112; B01D 2253/108; B01D 2253/106; B01D 2253/104; B01D 2253/116; B01D 2253/1124; B01D 2253/102

(57) ABSTRACT

A hydrogen recycle system comprises a processing device, an electrochemical hydrogen purification device and a dewatering device. The processing device is used to receive and process a mixed gas and to remove harmful substances; the electrochemical hydrogen purification device is connected with the processing device and used to remove non-hydrogen gases and impurities in the mixed gas; and the dewatering device is connected with the electrochemical hydrogen purification device and used to remove moisture in the purified hydrogen.

### BACKGROUND OF THE INVENTION

### Field of Invention

The invention relates to a hydrogen recycle system, and more particularly to a hydrogen recycle system capable of effectively recovering and reusing hydrogen and capable of producing purified hydrogen with high purity.

### Related Art

After the general semiconductor processing and photoelectric processing are completed, the gases (i.e., waste gases) remained after the processes usually contain ammonia (NH3), silane (SiH4), disilane (Si2H6), phosphine (PH3), arsenic hydride (AsH3), trimethylgallium (Ga(CH3)3) and high-concentration hydrogen. Among them, ammonia, silane, disilane, phosphine, arsenic hydride, and trimethylgallium are all environmental pollutants.

At present, the treatment method for the above-mentioned environmental pollutants is usually to discharge the waste gases directly into the atmosphere after being washed with sulfuric acid or hypochlorous acid. However, this treatment method has many disadvantages, for example, the nitrogen concentration in the treated wastewater reaches tens of thousands of ppm, which is much higher than the regulation standard. In addition, discharging hydrogen directly into the atmosphere has a risk of explosion and causes a waste of hydrogen.

In addition, in the semiconductor processing, photoelectric processing, or chemical plant manufacturing process, the relevant manufacturers in the industries usually process the waste gases (such as the aforementioned various gases) remained after the manufacturing processes by combustion, and therefore, the manufacturing processes are more complicated and the equipment and processing costs are relatively more expensive.

### SUMMARY OF THE INVENTION

Therefore, in order to effectively solve the above-mentioned problems, a main object of the invention is to provide a hydrogen recycle system capable of effectively recovering and reusing hydrogen.

A secondary object of the invention is to provide a hydrogen recycle system capable of producing purified hydrogen with high purity.

Another secondary object of the invention is to provide a hydrogen recycle system with lower recovery process costs.

In order to achieve the above-mentioned objects, the invention provides a hydrogen recycle system comprising a processing device, an electrochemical hydrogen purification device and a dewatering device. The processing device is used to receive and process a mixed gas and to remove harmful substances from the electrochemical hydrogen purification device; the electrochemical hydrogen purification device is connected with the processing device and used to remove non-hydrogen gases in the mixed gas, and the dewatering device is connected with the electrochemical hydrogen purification device and used to remove moisture in the purified hydrogen.

Through the design of the system of the invention, the processing device is used to first receive and process the mixed gas discharged from a process, and remove harmful substances in the mixed gas such as nitrides, sulfides, and the electrochemical hydrogen purification device is used to remove non-hydrogen gases and impurities in the mixed gas, and then a pumping device is used to provide pressure to push the hydrogen in the electrochemical hydrogen purification device to the dewatering device, and finally the dewatering device is used to remove moisture in the purified hydrogen, thereby hydrogen with higher purity can be separated, and therefore, hydrogen can be recovered and reused effectively.

### BRIEF DESCRIPTION OF THE DRAWINGS

FIG. 1 is a block diagram of a preferred embodiment of a hydrogen recycle system of the invention;

FIG. 2 is an implementation diagram of an electrochemical hydrogen purification device of a preferred embodiment of the hydrogen recycle system of the invention; and

FIG. 3 is a block diagram of another embodiment of the hydrogen recycle system of the invention.

### DETAILED DESCRIPTION OF THE INVENTION

The above objects of the invention, as well as its structural and functional features, will be described in accordance with the preferred embodiments of the drawings.

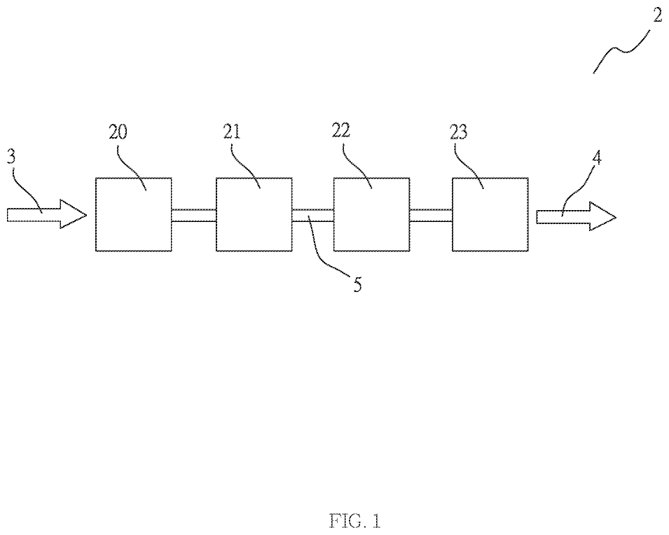

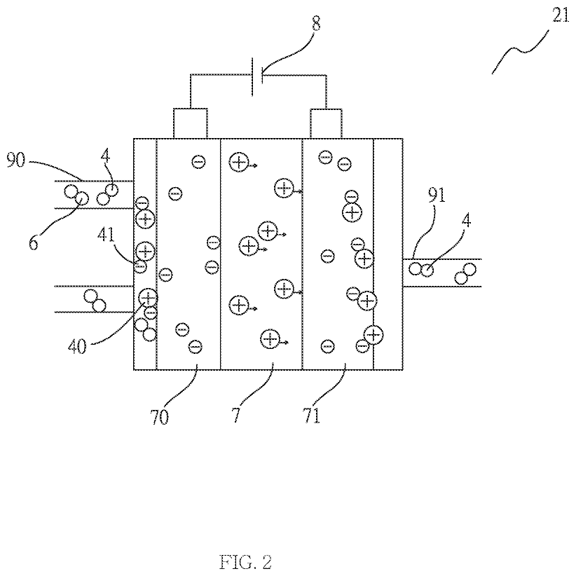

Please refer to FIGS. 1 and 2 for a block diagram of a preferred embodiment of a hydrogen recycle system 2 of the invention and an implementation diagram of an electrochemical hydrogen purification device. As shown in the figures, the hydrogen recycle system 2 comprises a processing device 20, an electrochemical hydrogen purification device 21, and a dewatering device 23. In the invention, the hydrogen recycle system 2 recovers and reuses hydrogen 4 from a mixed gas 3 formed with and containing hydrogen 4, nitrogen 6, and other gases. The mixed gas 3 is, for example, waste gases remained after completion of semiconductor processing or photoelectric processing, which contains hydrogen 4, nitrogen 6, ammonia, silane, disilane, phosphine, arsenic hydride, trimethylgallium or combinations of the above chemicals.

Firstly, the mixed gas 3 is first discharged to the processing device 20 through a pipeline 5, the processing device 20 is selected as a local scrubber, through the local scrubber the mixed gas 3 is preliminarily treated to remove toxic gases or particles (such as dust) or harmful substances (such as nitrides, sulfides) in the mixed gas 3, leaving harmless gases to enter the electrochemical hydrogen purification device 21. It should be explained that the local scrubber can be divided into electric and hot water scrubbing type, filled water scrubbing type, and dry adsorption type according to the principles. In the hydrogen recycle system 2 of the invention, the type of the local scrubber with which the mixed gas 3 needs to be treated depends on the requirements of users, and therefore, the various types of the processing device 20 are included in the scope of the invention.

Then, the washed mixed gas 3 is sent to the electrochemical hydrogen purification device 21 through the pipeline 5, and the electrochemical hydrogen purification device 21 is used to remove gases other than the hydrogen 4 and other impurities in the mixed gas 3. It should be explained that the electrochemical hydrogen purification device 21 selects an electrochemical method to remove gases other than the hydrogen 4 and other impurities in the mixed gas 3, in other words, gases (such as the hydrogen 4, the nitrogen 6, ammonia) other than the hydrogen 4 and other impurities in the mixed gas 3 are separated and removed in the electrochemical hydrogen purification device 21 by using an electrochemical method, so that only the hydrogen 4 is retained in the electrochemical hydrogen purification device 21, thus all the gases in the mixed gas 3 except the hydrogen 4 have been separated and do not exist, and the hydrogen 4 enters the dewatering device 23 through the pipeline 5.

Please refer to FIG. 2, which further illustrates that the electrochemical hydrogen purification device 21 further has an inlet passage 90, a proton exchange membrane 7, an anode catalyst reaction layer 70, a cathode catalyst reaction layer 71, an outlet passage 91, and an external power source 8. The inlet passage 90 communicates with the processing device 20, the mixed gas 3 treated in the processing device 20 will enter into the electrochemical hydrogen purification device 21 through the inlet passage 90, and then the proton exchange membrane 7 is used to block gases other than the hydrogen 4, and through the proton exchange membrane 7 a plurality of hydrogen ions 40 can be transmitted and a plurality of electrons 41 can be isolated from passing. The anode catalyst reaction layer 70 and the cathode catalyst reaction layer 71 are respectively disposed on opposite sides of the proton exchange membrane 7, platinum (Pt) or ruthenium (Ru) or other noble metals are provided by the anode catalyst reaction layer 70 and the cathode catalyst reaction layer 71 as a catalyst for an electrochemical reaction, and then a product (the product refers to the hydrogen 4) is diffused and discharged through the outlet passage 91 to complete the removal of gases and impurities other than the hydrogen 4 in the mixed gas 3.

Then, the hydrogen 4 passes through a pumping device 22 before entering the dewatering device 23, and the pumping device 22 is used to provide pressure to push the hydrogen 4 in the electrochemical hydrogen purification device 21 to the dewatering device 23. Since the hydrogen 4 separated by the electrochemical hydrogen purification device 21 still contains some moisture, the moisture needs to be removed through the dewatering device 23, and the dewatering device 23 selects to use a freezing method for moisture removal to remove moisture in the purified hydrogen 4, thereby the hydrogen 4 with higher purity can be separated.

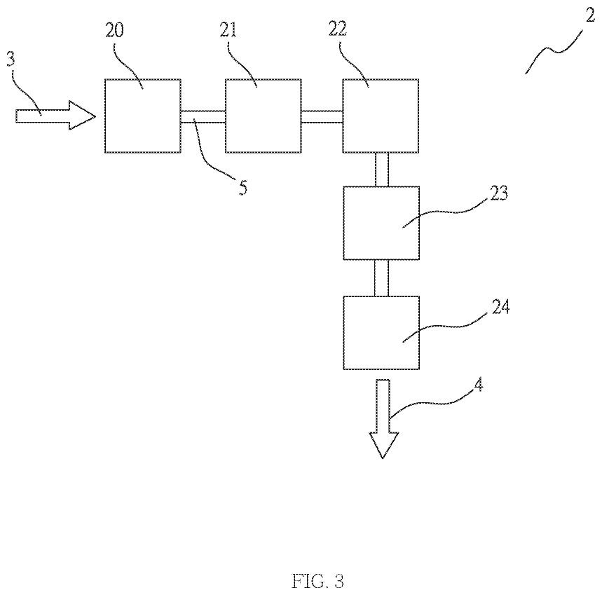

In addition, please refer to FIG. 3 as well. It should be explained that the invention can further comprise an adsorption element 24 connected to the dewatering device 23, and the adsorption element 24 is used to adsorb moisture in the purified hydrogen 4. In other words, the adsorption element 24 can be used as an auxiliary element of the dewatering device 23, so that a removal rate of moisture in the separated hydrogen 4 is faster and a purity of the hydrogen 4 is higher to achieve a multiplying effect. The adsorption element 24 can be selected from any one of the following materials: activated carbon, zeolite, silica gel, activated alumina, molecular sieve, manganese oxide, calcium hydroxide, graphene or hollow fiber.

In this way, through the various functions of the aforementioned devices, the high-purity hydrogen 4 can be separated, and the hydrogen recycle system 2 with high efficiency for recovering and reusing the hydrogen 4 can be formed. In addition, the costs of the recovery process of the invention are relatively lower compared with conventional hydrogen recovery methods, which greatly reduces the costs of recovering the hydrogen 4.

Based on the above, the invention has the following advantages compared with the prior art:

1. capable of recovering and reusing hydrogen effectively;

2. capable of producing purified hydrogen with high purity; and

3. the costs of the recovery process are relatively lower.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A hydrogen recycle system comprising:
a processing device used to receive and process a mixed gas and to remove harmful substances;
an electrochemical hydrogen purification device connected with the processing device, the electrochemical hydrogen purification device being used to remove non-hydrogen gases in the mixed gas; and
a dewatering device connected with the electrochemical hydrogen purification device, and the dewatering device being used to remove moisture in the purified hydrogen.

2. The hydrogen recycle system as claimed in claim 1, wherein the processing device is selected as a local scrubber.

3. The hydrogen recycle system as claimed in claim 1, wherein the mixed gas comprises, but is not limited to hydrogen, nitrogen, ammonia, argon, silicon compounds, phosphorus compounds, arsenic compounds, gallium compounds, indium compounds or combinations of the above chemicals.

4. The hydrogen recycle system as claimed in claim 1, further comprising a pumping device connected to the electrochemical hydrogen purification device, and the pumping device being used to provide pressure to push the hydrogen out of the electrochemical hydrogen purification device.

5. The hydrogen recycle system as claimed in claim 4, further comprising an adsorption element connected to the pumping device, and being used to adsorb moisture in the purified hydrogen, and the adsorption element being selected from any one of activated carbon, zeolite, silica gel, activated alumina, molecular sieve, manganese oxide, calcium hydroxide, graphene or hollow fiber.

6. The hydrogen recycle system as claimed in claim 1, wherein the dewatering device selects to use a freezing method for moisture removal to remove moisture in the purified hydrogen.

7. The hydrogen recycle system as claimed in claim 1, wherein the electrochemical hydrogen purification device further has an inlet passage, a proton exchange membrane, an anode catalyst reaction layer, a cathode catalyst reaction layer, an outlet passage, and an external power source, the inlet passage communicates with the processing device, the proton exchange membrane is used to transmit a plurality of hydrogen ions and to isolate a plurality of electrons from passing, the anode catalyst reaction layer and the cathode catalyst reaction layer are respectively disposed on opposite sides of the proton exchange membrane, platinum (Pt) or ruthenium (Ru) or other noble metals are provided by the anode catalyst reaction layer and the cathode catalyst reaction layer as a catalyst for an electrochemical reaction, and then a product is diffused and discharged through the outlet passage.
